(19) United States
(12) Patent Application Publication
(10) Pub. No.: US 2026/0188809 A1
(43) Pub. Date: Jul. 2, 2026

(54) Battery Assembly and Method of Assembling the Same

(71) Applicant: SK On Co., Ltd., Seoul (KR)

(72) Inventors: A Ra Jo, Daejeon (KR); Yun Joo Noh, Daejeon (KR)

(21) Appl. No.: 19/430,756

(22) Filed: Dec. 23, 2025

(30) Foreign Application Priority Data
Dec. 26, 2024 (KR) 10-2024-0197224

(51) Int. Cl. H01M 50/211; H01M 10/658; H01M 50/222; H01M 50/224; H01M 50/24; H01M 50/244; H01M 50/291; H01M 50/30

(52) U.S. Cl. CPC H01M 50/211; H01M 10/658; H01M 50/222; H01M 50/224; H01M 50/24; H01M 50/244; H01M 50/291; H01M 50/394

(57) ABSTRACT

A battery assembly and a method of assembling the same are provided. The battery assembly includes a plurality of battery cells arranged along a stacking direction, a receiving case forming a receiving space for receiving the plurality of battery cells, a plurality of flame-retardant members disposed between one surface of the receiving case and the plurality of battery cells, a partition portion located between the plurality of flame-retardant members along the stacking direction to separate the plurality of flame-retardant members from each other, and a plurality of venting holes penetrating the one surface of the receiving case and disposed so as to overlap the plurality of flame-retardant members.

### CROSS-REFERENCE TO RELATED APPLICATION

The present application claims priority to Korean Patent Application No. 10-2024-0197224 filed Dec. 26, 2024, the disclosure of which is hereby incorporated by reference in its entirety.

### BACKGROUND

### 1. Technical Field

The present disclosure relates to a battery assembly and a method of assembling the same.

### 2. Technical Considerations

Recently, due to fires or explosion accidents occurring during the use of lithium secondary batteries, social concerns regarding the safety of battery use have been increasing. Based on such social concerns, one of the major development tasks of lithium secondary batteries in recent times is to eliminate instability such as fire or explosion caused by thermal runaway of a battery cell.

In particular, in a battery module/pack, there exists an empty space other than the battery cells that serve as the energy source. If a fire occurs due to an external impact or a problem of the battery cell, the flame may be transferred to an adjacent cell through the empty space, and damage caused by the fire may increase. There is a need to smoothly discharge smoke or gas generated during the thermal runaway of the battery cell to the outside along an intended direction.

### SUMMARY

According to some non-limiting aspects of the present disclosure, an object to be solved is to improve thermal stability of a battery assembly.

According to some non-limiting aspects of the present disclosure, an object to be solved is to improve lifetime of a battery assembly.

According to some non-limiting aspects of the present disclosure, an object to be solved is to smoothly discharge high-temperature smoke or gas generated during thermal runaway of a battery cell to the outside.

According to some non-limiting aspects of the present disclosure, an object to be solved is to prevent flame from being re-introduced through venting holes applied for discharge of high-temperature smoke or gas.

According to some non-limiting aspects of the present disclosure, an object to be solved is to minimize heat propagation inside a battery assembly.

Meanwhile, the battery assembly according to the present disclosure may be widely applied in green technology fields such as electric vehicles (EVs), battery charging stations, energy storage systems (ESSs), and photovoltaics and wind power generation that use batteries. In addition, the battery assembly according to the present disclosure may be used in eco-friendly mobility including electric vehicles and hybrid vehicles for preventing climate change by suppressing air pollution and greenhouse gas emissions.

As a technical means to achieve the technical objects, a battery assembly according to non-limiting embodiments of the present disclosure includes a plurality of battery cells arranged along a stacking direction, a receiving case forming a receiving space for receiving the plurality of battery cells, a plurality of flame-retardant members disposed between one surface of the receiving case and the plurality of battery cells, a partition portion located between the plurality of flame-retardant members along the stacking direction to separate the plurality of flame-retardant members from each other, and a plurality of venting holes penetrating the one surface of the receiving case and disposed so as to overlap the plurality of flame-retardant members.

In addition, melting points of the respective flame-retardant members may be higher than a melting point of the receiving case.

In addition, each of the flame-retardant members may include any one of copper (Cu) or nickel (Ni), or a combination thereof.

In addition, thicknesses of the respective flame-retardant members may be equal to or less than a thickness of the receiving case.

In addition, each of the flame-retardant members may have porosity.

In addition, PPI (pores per inch) of the respective flame-retardant members may be a value of 10 or more and 1500 or less.

In addition, thermal conductivities of the respective flame-retardant members may be values of 1 W/m·K or more and 100 W/m·K or less.

In addition, each of the flame-retardant members may include a metal foam or a combination of ceramic wool and a metal foam.

In addition, at least a portion of the flame-retardant members may be exposed to outside through the venting holes.

In addition, each of the plurality of battery cells may include an electrode assembly; a body portion including the electrode assembly; and a lead tab portion electrically connected to the electrode assembly and protruding to an outside of the body portion, and the venting holes may be disposed to overlap the lead tab portion.

In addition, each of the plurality of venting holes may be disposed to be adjacent to a side surface of the receiving case along the stacking direction.

In addition, the receiving case may include a receiving cover forming an upper surface of the receiving space; a receiving bottom surface facing the receiving cover and supporting the plurality of battery cells; and a first receiving side surface and a second receiving side surface extending from the receiving bottom surface toward the receiving cover and forming both side surfaces of the receiving space along the stacking direction, and the venting holes may include first venting holes formed in the receiving cover and disposed closer to the second receiving side surface than to the first receiving side surface, and second venting holes formed in the receiving cover and disposed closer to the first receiving side surface than to the second receiving side surface.

In addition, a heat blocking member disposed between the plurality of battery cells along the stacking direction may be further included.

In addition, the partition portion may extend in a direction perpendicular to the stacking direction to separate adjacent ones of the plurality of battery cells from each other.

As a technical means to achieve the technical objects, a method of assembling a battery assembly including a plurality of battery cells, a receiving case for receiving the plurality of battery cells, and a partition portion located between a plurality of flame-retardant members along a stacking direction to separate the plurality of flame-retardant members from each other, is provided, the method comprising: receiving the plurality of battery cells arranged along the stacking direction in a receiving body that is a part of the receiving case; coupling the plurality of flame-retardant members and the partition portion on upper portions of the plurality of battery cells; and coupling a receiving cover on the plurality of flame-retardant members, the receiving cover being coupled to the receiving body to form the receiving case together with the receiving body and including a plurality of venting holes disposed so as to overlap the plurality of flame-retardant members.

In addition, the method may further include disposing a heat blocking member between adjacent ones of the plurality of battery cells to separate the adjacent battery cells from each other.

According to some non-limiting embodiments of the present disclosure, an object to be solved is to improve thermal stability of a battery assembly.

According to some non-limiting embodiments of the present disclosure, an object to be solved is to improve lifetime of a battery assembly.

According to some non-limiting embodiments of the present disclosure, an object to be solved is to smoothly discharge high-temperature smoke or gas generated during thermal runaway of a battery cell to the outside.

According to some non-limiting embodiments of the present disclosure, an object to be solved is to prevent flame from being re-introduced through venting holes applied for discharge of high-temperature smoke or gas.

According to some non-limiting embodiments of the present disclosure, an object to be solved is to minimize heat propagation inside a battery assembly.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

FIG. 1 is a diagram illustrating a battery assembly according to some non-limiting

embodiments according to the principles of the present disclosure;

FIG. 2 is an exploded perspective view of the battery assembly of FIG. 1;

FIG. 3 is a diagram illustrating an example of a cross-section taken along line A-A′ of the battery assembly of FIG. 1;

FIG. 4 is a diagram illustrating an example of a cross-section taken along line A-A′ of the battery assembly of FIG. 1;

FIG. 5 is a diagram illustrating a battery assembly according to some non-limiting embodiments according to the principles of the present disclosure;

FIG. 6 is an exploded perspective view of the battery assembly of FIG. 5; and

FIG. 7 is a flowchart illustrating a method of assembling a battery assembly according to non-limiting embodiments according to the principles of the present disclosure.

### DETAILED DESCRIPTION

It is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects of the disclosed subject matter. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. The singular form of the term used herein may be intended to also include a plural form, unless otherwise indicated. As used herein, the singular form of “a”, “an”, and “the” include plural referents unless the context clearly states otherwise.

For the purposes of this disclosure, unless otherwise indicated, all numbers expressing quantities of ingredients, reaction conditions, dimensions, physical characteristics, and so forth used in the disclosure are to be understood as being modified in all instances by the term “about.” Unless indicated to the contrary, the numerical parameters set forth in the present disclosure are approximations that can vary depending upon the desired properties sought to be obtained by the present disclosure.

The numerical ranges used in the present specification includes all values within the ranges including the lower limit and the upper limit, increments logically derived from the form and spanning of a defined range, all double limited values, and all possible combinations of the upper limit and the lower limit of the numerical range defined in different forms. Unless otherwise defined in the present disclosure, values which may be outside of a numerical range due to experimental error or rounding off of a value are also included in the defined numerical range.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

Also, it should be understood that any numerical range recited herein is intended to include all sub-ranges subsumed therein. For example, a range of “1 to 10” is intended to include any and all sub-ranges between and including the recited minimum value of 1 and the recited maximum value of 10, that is, all subranges beginning with a minimum value equal to or greater than 1 and ending with a maximum value equal to or less than 10, and all subranges in between, e.g., 1 to 6.3, or 5.5 to 10, or 2.7 to 6.1.

The term “comprise” mentioned in the present disclosure is an open-ended description having a meaning equivalent to the term such as “include”, “is/are provided”, “contain”, or “have”, and does not exclude elements, materials, or processes which are not further listed.

Hereinafter, non-limiting embodiments of the present disclosure will be described in detail with reference to the accompanying drawings. The configuration of the device or the control method described below is merely for describing non-limiting embodiments of the present disclosure, and is not intended to limit the scope of the present disclosure, and reference numerals used consistently throughout the specification denote the same components.

Meanwhile, the battery assembly according to the present disclosure is a concept collectively referring to a battery module, a battery pack, and an energy storage system (ESS). The battery module refers to a battery assembly in which a plurality of battery cells are bundled in one or more numbers to protect them from external impact, heat, vibration, and the like, and then placed in a case. The battery pack refers to a battery assembly that accommodates a predetermined number of the battery modules to obtain a desired voltage or power.

In addition, the battery assembly according to the present disclosure may refer to a battery pack of a cell-to-pack (CTP) structure in which the battery module is omitted and a predetermined number of the plurality of battery cells are accommodated to generate a desired voltage or power.

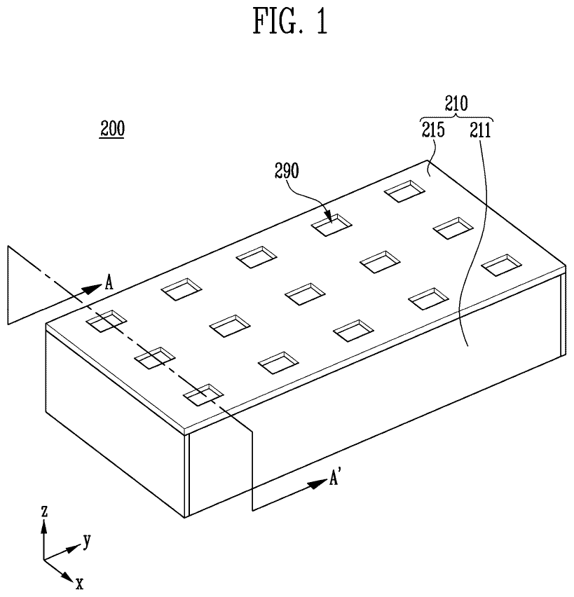

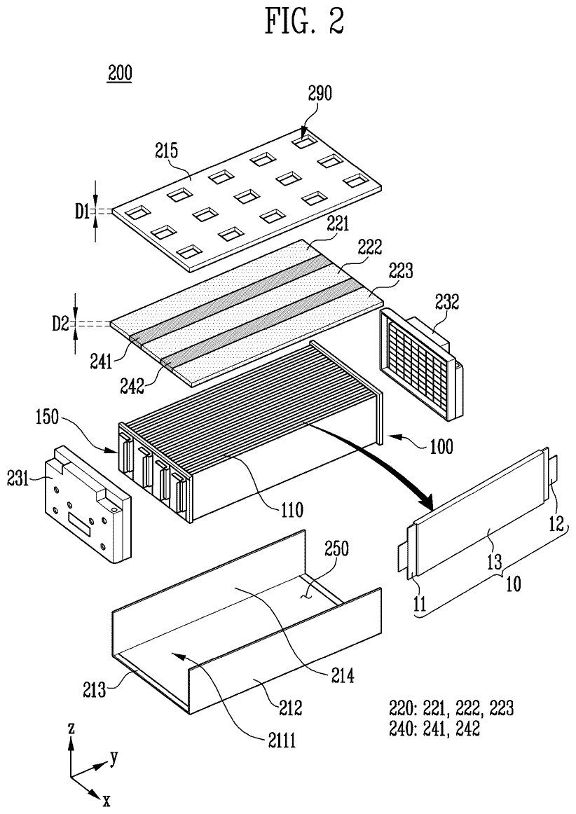

FIG. 1 is a diagram illustrating a battery assembly according to some non-limiting embodiments. FIG. 2 is an exploded perspective view of the battery assembly of FIG. 1.

Referring to FIG. 1 and FIG. 2, a battery assembly 200 according to some non-limiting embodiments may include a plurality of battery cells 110, a receiving body 211 including an opening 2111 on one surface and forming a receiving space 250 for receiving the plurality of battery cells 110 through the opening 2111, a receiving cover 215 coupled to the receiving body 211 to cover the opening 2111 and form the receiving space 250 together with the receiving body 211, and venting holes 290 formed to penetrate the receiving cover 215.

The battery assembly 200 according to some non-limiting embodiments may include flame-retardant members 220 and partition portions 240 disposed between the receiving cover 215 and the plurality of battery cells 110.

The battery assembly 200 may include a plurality of battery cells 110 therein. To this end, the battery assembly 200 may include a receiving case 210 that receives the plurality of battery cells 110 therein. Referring to FIG. 2, the receiving case 210 may further include a receiving body 211 forming at least a portion of the receiving space 250 that receives the battery cells 110, and a receiving cover 215 coupled to the receiving body 211 to form the receiving space 250 together with the receiving body 211.

Specifically, the receiving body 211 may include an opening 2111 on one surface. Considering venting of gas, it is preferable that the opening 2111 is formed on an upper surface of the receiving body 211, but it may alternatively be formed on another surface.

The opening 2111 may be formed such that an entire upper surface of the receiving body 211 is opened, or it may be formed such that only a portion of the upper surface of the receiving body 211 is opened.

Referring to FIG. 2, the battery cells 110 may be provided as a plurality. Any one battery cell 10 among the battery cells 110 may include a body portion 13 that produces or stores electrical energy, and lead tab portions 11 and 12 protruding to an outside of the body portion 13 from the body portion 13. The body portion 13 may include an electrode assembly (not shown) including a positive electrode and a negative electrode therein for producing and storing electrical energy.

The plurality of battery cells 110 may be stacked along a predetermined stacking direction (for example, an X-direction). The plurality of battery cells 110 may be stacked along the stacking direction (for example, the X-direction) to form a cell stack 100. The cell stack 100 may include a busbar 150 for electrically connecting the plurality of battery cells 110.

The receiving body 211 may form a receiving space 250 for receiving the cell stack 100. The receiving body 211 may include a receiving bottom surface 213 that is a bottom surface of the receiving space 250, and first and second receiving side surfaces 212 and 214 that are bent from opposite edges among edges of the receiving bottom surface 213 and positioned to face each other.

Referring to FIG. 2, the receiving body 211 may be formed in an angled U-shape or a channel shape by the receiving bottom surface 213 and the first and second receiving side surfaces 212 and 214. More specifically, the receiving body 211 may be a U-shape or a channel shape extending along a Y-direction.

Accordingly, both ends of the receiving body 211 along the Y-direction may also be opened. The receiving case 210 may further include end plates 231 and 232 coupled to both ends of the receiving body 211 and to the receiving cover 215 to cover both ends of the receiving body 211.

Meanwhile, one surface of the receiving case 210 (for example, the receiving cover 215) may include venting holes 290 formed to penetrate the one surface of the receiving case 210 (for example, the receiving cover 215). Referring to FIG. 1 and FIG. 2, the venting holes 290 are illustrated as being formed to penetrate the receiving cover 215, but embodiments of the present disclosure are not necessarily limited thereto.

For example, the venting holes 290 may be located on the end plates 231 and 232, or may be located on the first and second receiving side surfaces 212 and 214. As long as gas and smoke generated from the battery cells 110 that have undergone thermal runaway can be smoothly discharged through the venting holes 290, the venting holes 290 may be located anywhere. However, in order to minimize or delay heat propagation from the battery cells 110 that have undergone thermal runaway to other battery cells 110 of the cell stack 100, it is preferable that gas and smoke generated from the battery cells 110 that have undergone thermal runaway are discharged through an upper surface of the receiving space 250 along a height direction of the receiving case 210. To this end, the receiving cover 215 may include the venting holes 290 formed to penetrate the receiving cover 215. Hereinafter, for convenience of description, it is assumed that the venting holes 290 are disposed on the receiving cover 215.

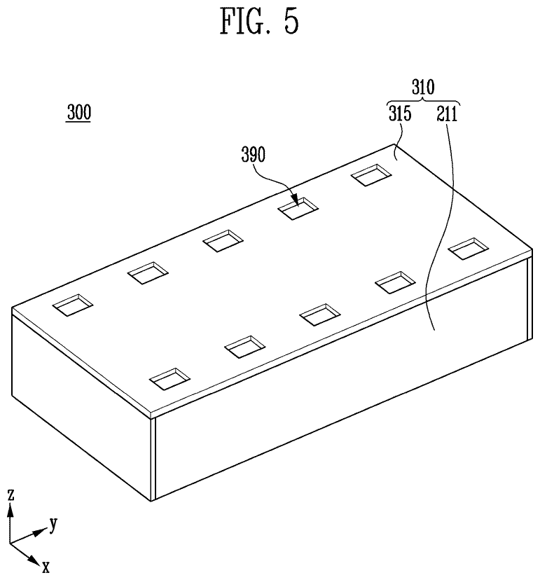

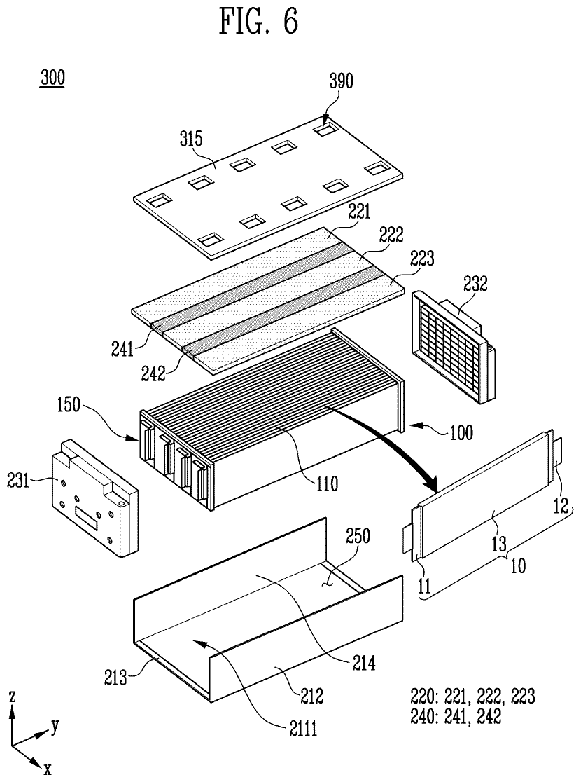

The venting holes 290 may be disposed on the receiving cover 215 and may have various arrangement forms. For example, as illustrated in FIG. 1 and FIG. 2, the venting holes 290 may be disposed on the receiving cover 215. For example, as illustrated in FIG. 5 and FIG. 6, the venting holes 390 may be disposed to be adjacent to a side surface of the receiving cover 315. The arrangement form of the venting holes 290 is not limited to those illustrated in FIG. 1, FIG. 2, FIG. 5, and FIG. 6.

Sizes of the venting holes 290 may vary according to the arrangement form of the venting holes 290 on the receiving cover 215.

The flame-retardant members 220 may be disposed between the battery cells 110 and the receiving cover 215. The flame-retardant members 220 may be disposed on the battery cells 110, and the receiving cover 215 may be disposed on the flame-retardant members 220.

The flame-retardant members 220 may include a material having excellent breathability so that gas and smoke generated from the battery cells 110 that have undergone thermal runaway may be smoothly discharged to an outside (for example, an outside of the battery assembly 200) through the venting holes 290 formed in the receiving cover 215 via the flame-retardant members 220. Pressure inside the battery assembly 200 may be set higher than pressure outside the battery assembly 200 so that gas and smoke generated by the battery cells 110 that have undergone thermal runaway may have a unidirectional flow from the inside of the battery assembly 200 to the outside of the battery assembly 200.

As high-temperature gas and smoke are smoothly discharged to the outside, a cooling effect that effectively lowers a temperature inside the battery assembly 200 may be expected. In addition, as high-temperature gas and smoke are smoothly discharged to the outside, high pressure generated when the battery cells 110 explode may be effectively reduced. High pressure inside the battery assembly 200 may accelerate convection of high-temperature gas and smoke generated from the battery cells 110 that have undergone thermal runaway, which may cause accelerated heat transfer between the battery cells 110. By effectively reducing the high pressure generated when the battery cells 110 explode, it may be possible to prevent heat transfer and fire inside the battery assembly 200.

Battery cells 110 that have undergone thermal runaway may generate flames in addition to high-temperature gas and smoke, depending on the situation. However, the generated flames may not pass through the flame-retardant members 220. The flame-retardant members 220 may prevent flames generated from the battery cells 110 that have undergone thermal runaway from being discharged to the outside through the venting holes 290. In addition, the flame-retardant members 220 may prevent flames from the outside from being introduced toward the battery cells 110.

If the flame-retardant members 220 are not disposed, flames generated from some of the battery cells 110 that have undergone thermal runaway may be discharged to the outside through the venting holes 290 and then re-introduced into the inside of the battery assembly 200 through the venting holes 290, whereby flames may be propagated between the battery cells 110. Or, flames generated outside the battery assembly 200 may be introduced to the battery cells 110 through the venting holes 290.

However, the battery assembly 200 according to some non-limiting embodiments may prevent flames generated from some of the battery cells 110 that have undergone thermal runaway from being propagated between the battery cells 110, as well as prevent flames from the outside from being introduced to the battery cells 110, by including the flame-retardant members 220.

Melting points of the respective flame-retardant members 220 may be higher than a melting point of the receiving cover 215. Here, the melting point may be defined as a temperature required for at least a portion of a substance to change its state from a solid state to a liquid state. For example, when the receiving cover 215 includes aluminum (Al), melting points of the respective flame-retardant members 220 may be higher than 660° C. As an example, each of the flame-retardant members 220 may include any one of copper (Cu) or nickel (Ni).

Thicknesses of the respective flame-retardant members 220 may be equal to or less than a thickness of the receiving cover 215. As illustrated in FIG. 2, when a thickness of each of the flame-retardant members 220 is a second length D2 and a thickness of the receiving cover 215 is a first length D1, a size of the second length D2 may be less than or equal to a size of the first length D1.

The flame-retardant members 220 may have porosity. PPI (pores per inch) of the respective flame-retardant members 220 may be a value of 10 or more and 1500 or less. Here, PPI is a value indicating “number of pores per inch.”

Each of the flame-retardant members 220 may include a metal foam or a combination of ceramic wool and a metal foam. Thermal conductivities of the respective flame-retardant members 220 may be values of 1 W/m·K or more and 100 W/m·K or less.

The plurality of flame-retardant members 220 may be separated from each other by the partition portions 240. For example, as illustrated in FIG. 2, when the flame-retardant members 220 are assumed to be three in total, first and second flame-retardant members 221 and 222 may be separated from each other by the first partition portion 241, and second and third flame-retardant members 222 and 223 may be separated from each other by the second partition portion 242.

The flame-retardant members 220 may each be disposed to overlap the venting holes 290 in a height direction (for example, a z-direction) of the battery assembly 200. By disposing the flame-retardant members 220 such that each flame-retardant member 220 overlaps the venting holes 290, only high-temperature smoke and gas generated from the battery cells 110 that have undergone thermal runaway may be selectively discharged to the outside through the venting holes 290 via the flame-retardant members 220. Flames generated from the battery cells 110 that have undergone thermal runaway may not pass through the flame-retardant members 220. Through this, flames may be prevented from being propagated across an entire region of the battery cells 110 via the venting holes 290.

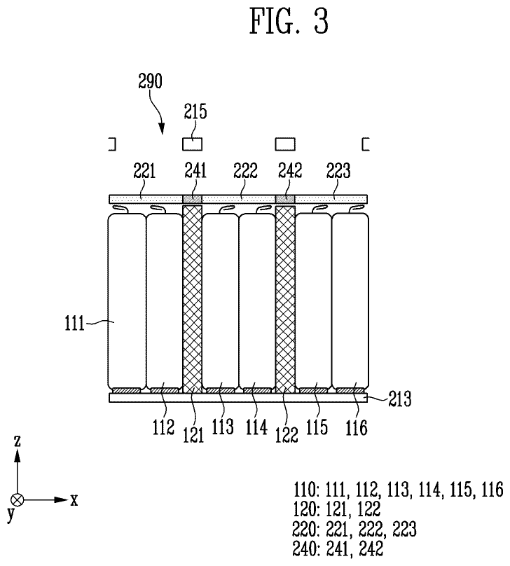

FIG. 3 is a diagram illustrating an example of a cross-section taken along line A-A′ of the battery assembly of FIG. 1. FIG. 3 is a diagram illustrating a view of the battery assembly of FIG. 1, which is cut along line A-A′ and viewed in a y-direction.

Referring to FIG. 1 and FIG. 3, the battery assembly 200 may include the battery cells 110, the heat blocking members 120, the flame-retardant members 220, and the partition portions 240.

The battery cells 110 may include first to sixth battery cells 111 to 116. The heat blocking members 120 may include first and second heat blocking members 121 and 122. The flame-retardant members 220 may include first to third flame-retardant members 221 to 223. The partition portions 240 may include first and second partition portions 241 and 242.

The battery cells 110 illustrated in FIG. 3 may be divided into two groups according to arrangement directions of a positive electrode and a negative electrode. For example, the first battery cell 111, the second battery cell 112, the fifth battery cell 115, and the sixth battery cell 116 may form one group because their arrangement directions of the positive electrode and the negative electrode are the same. The third battery cell 113 and the fourth battery cell 114 may form another group because their arrangement directions of the positive electrode and the negative electrode differ from those of the one group.

Battery cells included in the same group based on the arrangement directions of the positive electrode and the negative electrode may be electrically connected in parallel. Battery cells included in different groups based on the arrangement directions of the positive electrode and the negative electrode may be electrically connected in series. For example, the first battery cell 111 and the second battery cell 112 may be electrically connected in parallel. The first battery cell 111 and the third battery cell 113 may be electrically connected in series.

Heat blocking members 120 may be disposed between battery cells included in different groups based on arrangement directions of the positive electrode and the negative electrode to block heat conduction. For example, the first heat blocking member 121 may be disposed between the second battery cell 112 and the third battery cell 113, and the second heat blocking member 122 may be disposed between the fourth battery cell 114 and the fifth battery cell 115. The first heat blocking member 121 may block heat conduction between the second battery cell 112 and the third battery cell 113, and the second heat blocking member 122 may block heat conduction between the fourth battery cell 114 and the fifth battery cell 115.

The heat blocking members 120 may overlap the partition portions 240 in a height direction (for example, a z-direction) of the battery assembly 200. For example, the first heat blocking member 121 may overlap the first partition portion 241, and the second heat blocking member 122 may overlap the second partition portion 242.

The plurality of flame-retardant members 220 may be separated from each other by the partition portions 240. For example, the first and second flame-retardant members 221 and 222 may be separated from each other by the first partition portion 241, and the second and third flame-retardant members 222 and 223 may be separated from each other by the second partition portion 242.

The plurality of flame-retardant members 220 may overlap the battery cells 110 in a height direction (for example, a z-direction) of the battery assembly 200. For example, the first and second battery cells 111 and 112 may overlap the first flame-retardant member 221, the third and fourth battery cells 113 and 114 may overlap the second flame-retardant member 222, and the fifth and sixth battery cells 115 and 116 may overlap the third flame-retardant member 223.

As the battery cells 110 overlap the plurality of flame-retardant members 220 and the plurality of flame-retardant members 220 overlap the venting holes 290, the battery cells 110 may be disposed to overlap the plurality of venting holes 290. More specifically, the plurality of venting holes 290 may be disposed to overlap lead tab portions 11 and 12 of the respective battery cells 110. For example, a lead tab portion of the first battery cell 111 may be disposed to overlap a venting hole located on the first flame-retardant member 221. For example, a lead tab portion of the third battery cell 113 may be disposed to overlap a venting hole located on the second flame-retardant member 222. For example, a lead tab portion of the fifth battery cell 115 may be disposed to overlap a venting hole located on the third flame-retardant member 223.

At least a portion of the flame-retardant members 220 may be exposed to the outside through the venting holes 290. For example, the first flame-retardant member 221 may be exposed to the outside through a venting hole located on the first flame-retardant member 221. For example, the second flame-retardant member 222 may be exposed to the outside through a venting hole located on the second flame-retardant member 222. For example, the third flame-retardant member 223 may be exposed to the outside through a venting hole located on the third flame-retardant member 223.

Only high-temperature smoke and gas generated from the battery cells 110 that have undergone thermal runaway may selectively pass through the flame-retardant members 220, and flames generated from the battery cells 110 that have undergone thermal runaway may not pass through the flame-retardant members 220. For example, when the first and second battery cells 111 and 112 are in a thermal runaway state and generate flames and high-temperature smoke, the high-temperature smoke may pass through the first flame-retardant member 221 and be discharged to the outside through the venting holes 290. In contrast, the flames may not pass through the first flame-retardant member 221, and since the first heat blocking member 121 blocks heat conduction between the first and second battery cells 111 and 112 and other battery cells 110, flame propagation may be prevented.

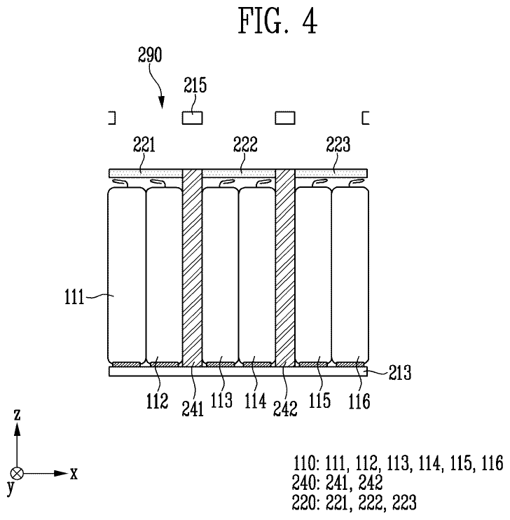

FIG. 4 is a diagram illustrating an example of a cross-section taken along line A-A′ of the battery assembly of FIG. 1.

Referring to FIG. 1 and FIG. 4, an example of FIG. 4 may differ from the example of FIG. 3 in that the battery assembly 200 does not separately include the heat blocking members 120 (see FIG. 3).

In the other example of FIG. 4, instead of separately including the heat blocking members 120, the partition portions 240 may perform a role of the heat blocking members 120.

The partition portions 240 may extend in a direction perpendicular to a stacking direction (for example, a z-direction) of the battery cells 110 and may be disposed between adjacent ones of the battery cells 110. The partition portions 240 may separate the adjacent ones of the battery cells 110 from each other. For example, the first partition portion 241 may extend in the z-direction and may be disposed between the second battery cell 112 and the third battery cell 113, and may separate the second battery cell 112 and the third battery cell 113 from each other. For example, the second partition portion 242 may extend in the z-direction and may be disposed between the fourth battery cell 114 and the fifth battery cell 115, and may separate the fourth battery cell 114 and the fifth battery cell 115 from each other.

The partition portions 240 may perform a function of separating the flame-retardant members 220 from each other and may also block heat conduction between battery cells 110 included in different groups based on arrangement directions of the positive electrode and the negative electrode. The battery cells 110 illustrated in FIG. 4 may be divided into two groups according to arrangement directions of the positive electrode and the negative electrode. For example, the first battery cell 111, the second battery cell 112, the fifth battery cell 115, and the sixth battery cell 116 may form one group because their arrangement directions of the positive electrode and the negative electrode are the same. The third battery cell 113 and the fourth battery cell 114 may form another group because their arrangement directions of the positive electrode and the negative electrode differ from those of the one group.

The second battery cell 112 and the third battery cell 113 may be included in different groups because their arrangement directions of the positive electrode and the negative electrode differ from each other, and the first partition portion 241 located between the second battery cell 112 and the third battery cell 113 may block heat conduction between the second battery cell 112 and the third battery cell 113. The fourth battery cell 114 and the fifth battery cell 115 may be included in different groups because their arrangement directions of the positive electrode and the negative electrode differ from each other, and the second partition portion 242 located between the fourth battery cell 114 and the fifth battery cell 115 may block heat conduction between the fourth battery cell 114 and the fifth battery cell 115.

The other example of FIG. 4, compared to the example of FIG. 3, has an effect of simplifying the process because it is not necessary to form separate heat blocking members 120.

FIG. 5 is a diagram illustrating a battery assembly according to some non-limiting embodiments. FIG. 6 is an exploded perspective view of the battery assembly of FIG. 5. Descriptions overlapping with those referring to FIG. 1 and FIG. 2 regarding the cell stack 100, the battery cells 110, the busbar 150, the receiving case 210, the receiving space 250, and the like will be omitted hereinafter.

Referring to FIG. 5 and FIG. 6, a battery assembly 300 according to some non-limiting embodiments may differ from the battery assembly 200 according to the non-limiting embodiment of FIG. 1 and FIG. 2 in that arrangement positions of the venting holes 390 may be different.

In the battery assembly 300 according to some non-limiting embodiments of FIG. 5 and FIG. 6, the venting holes 390 may be formed in the receiving cover 315 and may be disposed to be adjacent to a side surface of the receiving case 310. More specifically, the venting holes 390 may include first venting holes formed in the receiving cover 315 and disposed closer to the second receiving side surface 214 than to the first receiving side surface 212, and second venting holes disposed closer to the first receiving side surface 212 than to the second receiving side surface 214.

Battery cells 110 positioned adjacent to a side surface of the receiving case 310 are more likely to generate high-temperature gas and smoke due to thermal runaway, and therefore the venting holes 390 may be disposed adjacent to the side surface of the receiving case 310. The venting holes 390 may be disposed to overlap the battery cells disposed adjacent to the side surface of the receiving case 310 so that high-temperature gas and smoke generated from the battery cells disposed adjacent to the side surface of the receiving case 310 may be smoothly discharged to the outside.

The flame-retardant members 220 may be disposed between the battery cells 110 and the receiving cover 315. The flame-retardant members 220 may be disposed on the battery cells 110, and the receiving cover 315 may be disposed on the flame-retardant members 220.

The flame-retardant members 220 may include a material having excellent breathability so that gas and smoke generated from the battery cells 110 that have undergone thermal runaway may be smoothly discharged to the outside (for example, an outside of the battery assembly 300) through the venting holes 390 formed in the receiving cover 315 via the flame-retardant members 220.

As high-temperature gas and smoke are smoothly discharged to the outside, a cooling effect that effectively lowers a temperature inside the battery assembly 300 may be expected. In addition, as high-temperature gas and smoke are smoothly discharged to the outside, high pressure generated when the battery cells 110 explode may be effectively reduced. High pressure inside the battery assembly 300 may accelerate convection of high-temperature gas and smoke generated from the battery cells 110 that have undergone thermal runaway, which may cause accelerated heat transfer between the battery cells 110. By effectively reducing the high pressure generated when the battery cells 110 explode, it may be possible to prevent heat transfer and fire inside the battery assembly 300.

Battery cells 110 that have undergone thermal runaway may generate flames in addition to high-temperature gas and smoke, depending on the situation. However, the generated flames may not pass through the flame-retardant members 220. The flame-retardant members 220 may prevent flames generated from the battery cells 110 that have undergone thermal runaway from being discharged to the outside through the venting holes 390. In addition, the flame-retardant members 220 may prevent flames from the outside from being introduced toward the battery cells 110.

If the flame-retardant members 220 are not disposed, flames generated from some of the battery cells 110 that have undergone thermal runaway may be discharged to the outside through the venting holes 390 and then re-introduced into the inside of the battery assembly 300 through the venting holes 390, whereby flames may be propagated between the battery cells 110. Or, flames generated outside the battery assembly 300 may be introduced to the battery cells 110 through the venting holes 390.

However, the battery assembly 300 according to some non-limiting embodiments may prevent flames generated from some of the battery cells 110 that have undergone thermal runaway from being propagated between the battery cells 110, as well as prevent flames from the outside from being introduced to the battery cells 110, by including the flame-retardant members 220.

Melting points of the respective flame-retardant members 220 may be higher than a melting point of the receiving cover 315. For example, when the receiving cover 315 includes aluminum (Al), melting points of the respective flame-retardant members 220 may be higher than 660° C. As an example, each of the flame-retardant members 220 may include any one of copper (Cu) or nickel (Ni).

Thicknesses of the respective flame-retardant members 220 may be equal to or less than a thickness of the receiving cover 315.

The flame-retardant members 220 may have porosity. PPI (pores per inch) of the respective flame-retardant members 220 may be a value of 10 or more and 1500 or less. Here, PPI is a value indicating “number of pores per inch.”

Each of the flame-retardant members 220 may include any one of ceramic wool or a metal foam, or a combination thereof. Thermal conductivities of the respective flame-retardant members 220 may be values of 1 W/m·K or more and 100 W/m·K or less.

The plurality of flame-retardant members 220 may be separated from each other by the partition portions 240. For example, as illustrated in FIG. 6, when it is assumed that the flame-retardant members 220 are three in total, the first and second flame-retardant members 221 and 222 may be separated from each other by the first partition portion 241, and the second and third flame-retardant members 222 and 223 may be separated from each other by the second partition portion 242.

The flame-retardant members 220 may each be disposed to overlap the venting holes 390 in a height direction (for example, a z-direction) of the battery assembly 300. By disposing the flame-retardant members 220 such that each flame-retardant member 220 overlaps the venting holes 390, only high-temperature smoke and gas generated from the battery cells 110 that have undergone thermal runaway may be selectively discharged to the outside through the venting holes 390 via the flame-retardant members 220. Flames generated from the battery cells 110 that have undergone thermal runaway may not pass through the flame-retardant members 220. Through this, flames may be prevented from being propagated across an entire region of the battery cells 110 via the venting holes 390.

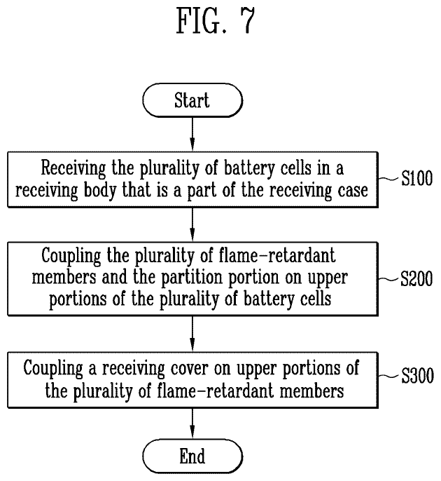

FIG. 7 is a flowchart illustrating a method of assembling a battery assembly according to non-limiting embodiments of the present disclosure. A method of assembling a battery assembly 300 according to some non-limiting embodiments of the present disclosure is substantially the same as a method of assembling the battery assembly 200 according to some non-limiting embodiments, and therefore, a description will be given hereinafter based on the battery assembly 200 according to some non-limiting embodiments. However, parts in which the battery assembly 300 according to some non-limiting embodiments differs from the battery assembly 200 according to some non-limiting embodiments will be described separately.

Referring to FIG. 1 to FIG. 7, in step S100, the plurality of battery cells 110 may be received in a receiving body 211 that is a part of the receiving case 210.

In step S200, the plurality of flame-retardant members 220 and the partition portion may be coupled on the plurality of battery cells 110.

The flame-retardant members 220 may include a material having excellent breathability so that gas and smoke generated from the battery cells 110 that have undergone thermal runaway may be smoothly discharged to the outside (for example, an outside of the battery assembly 200) through the venting holes 290 formed in the receiving cover 215 via the flame-retardant members 220.

As high-temperature gas and smoke are smoothly discharged to the outside, a cooling effect that effectively lowers a temperature inside the battery assembly 200 may be expected. In addition, as high-temperature gas and smoke are smoothly discharged to the outside, high pressure generated when the battery cells 110 explode may be effectively reduced. High pressure inside the battery assembly 200 may accelerate convection of high-temperature gas and smoke generated from the battery cells 110 that have undergone thermal runaway, which may cause accelerated heat transfer between the battery cells 110. By effectively reducing the high pressure generated when the battery cells 110 explode, it may be possible to prevent heat transfer and fire inside the battery assembly 200.

Battery cells 110 that have undergone thermal runaway may generate flames in addition to high-temperature gas and smoke, depending on the situation. However, the generated flames may not pass through the flame-retardant members 220. The flame-retardant members 220 may prevent flames generated from the battery cells 110 that have undergone thermal runaway from being discharged to the outside through the venting holes 290. In addition, the flame-retardant members 220 may prevent flames from the outside from being introduced toward the battery cells 110.

Melting points of the respective flame-retardant members 220 may be higher than a melting point of the receiving cover 215. For example, when the receiving cover 215 includes aluminum (Al), melting points of the respective flame-retardant members 220 may be higher than 660° C. As an example, each of the flame-retardant members 220 may include any one of copper (Cu) or nickel (Ni).

Thicknesses of the respective flame-retardant members 220 may be equal to or less than a thickness of the receiving cover.

Referring to FIG. 2 and FIG. 6, the plurality of flame-retardant members 220 may be separated from each other by the partition portions 240.

In an example referring to FIG. 2 and FIG. 3, a step of disposing a heat blocking member between adjacent ones of the plurality of battery cells may be further included. For example, the battery cells 110 may include first to sixth battery cells 111 to 116. The heat blocking members 120 may include first and second heat blocking members 121 and 122.

The battery cells 110 illustrated in FIG. 3 may be divided into two groups according to arrangement directions of a positive electrode and a negative electrode. For example, the first battery cell 111, the second battery cell 112, the fifth battery cell 115, and the sixth battery cell 116 may form one group because their arrangement directions of the positive electrode and the negative electrode are the same. The third battery cell 113 and the fourth battery cell 114 may form another group because their arrangement directions of the positive electrode and the negative electrode differ from those of the one group.

Heat blocking members 120 may be disposed between battery cells included in different groups based on arrangement directions of the positive electrode and the negative electrode to block heat conduction. For example, the first heat blocking member 121 may be disposed between the second battery cell 112 and the third battery cell 113, and the second heat blocking member 122 may be disposed between the fourth battery cell 114 and the fifth battery cell 115. The first heat blocking member 121 may block heat conduction between the second battery cell 112 and the third battery cell 113, and the second heat blocking member 122 may block heat conduction between the fourth battery cell 114 and the fifth battery cell 115.

The heat blocking members 120 may overlap the partition portions 240 in a height direction (for example, a z-direction) of the battery assembly 200. For example, the first heat blocking member 121 may overlap the first partition portion 241, and the second heat blocking member 122 may overlap the second partition portion 242.

In some examples, referring to FIG. 2 and FIG. 4, instead of including a step of disposing the heat blocking members 120, the partition portions 240 may perform a role of the heat blocking members 120.

The partition portions 240 may extend in a direction perpendicular to a stacking direction (for example, a z-direction) of the battery cells 110 and may be disposed between adjacent ones of the battery cells 110. The partition portions 240 may separate the adjacent ones of the battery cells 110 from each other. For example, the first partition portion 241 may extend in the z-direction and may be disposed between the second battery cell 112 and the third battery cell 113, and may separate the second battery cell 112 and the third battery cell 113 from each other. For example, the second partition portion 242 may extend in the z-direction and may be disposed between the fourth battery cell 114 and the fifth battery cell 115, and may separate the fourth battery cell 114 and the fifth battery cell 115 from each other.

The partition portions 240 may perform a function of separating the flame-retardant members 220 from each other and may also block heat conduction between battery cells 110 included in different groups based on arrangement directions of the positive electrode and the negative electrode. The battery cells 110 illustrated in FIG. 4 may be divided into two groups according to arrangement directions of the positive electrode and the negative electrode. For example, the first battery cell 111, the second battery cell 112, the fifth battery cell 115, and the sixth battery cell 116 may form one group because their arrangement directions of the positive electrode and the negative electrode are the same. The third battery cell 113 and the fourth battery cell 114 may form another group because their arrangement directions of the positive electrode and the negative electrode differ from those of the one group.

The second battery cell 112 and the third battery cell 113 may be included in different groups because their arrangement directions of the positive electrode and the negative electrode differ from each other, and the first partition portion 241 located between the second battery cell 112 and the third battery cell 113 may block heat conduction between the second battery cell 112 and the third battery cell 113. The fourth battery cell 114 and the fifth battery cell 115 may be included in different groups because their arrangement directions of the positive electrode and the negative electrode differ from each other, and the second partition portion 242 located between the fourth battery cell 114 and the fifth battery cell 115 may block heat conduction between the fourth battery cell 114 and the fifth battery cell 115.

In step S300, the receiving cover may be coupled on the plurality of flame-retardant members.

The receiving cover 215 may include the venting holes 290 formed to penetrate the receiving cover 215.

The venting holes 290 may be disposed on the receiving cover 215 and may have various arrangement forms. For example, as illustrated in FIG. 1 and FIG. 2, the venting holes 290 may be disposed as shown, or as illustrated in FIG. 5 and FIG. 6, the venting holes 390 may be disposed to be closer to both side surfaces of the receiving case 310. The arrangement form of the venting holes 290 is not limited to those illustrated in FIG. 1, FIG. 2, FIG. 5, and FIG. 6.

The flame-retardant members 220 may each be disposed to overlap the venting holes 290 in a height direction (for example, a z-direction) of the battery assembly 200. By disposing the flame-retardant members 220 such that each flame-retardant member 220 overlaps the venting holes 290, only high-temperature smoke and gas generated from the battery cells 110 that have undergone thermal runaway may be selectively discharged to the outside through the venting holes 290 via the flame-retardant members 220. Flames generated from the battery cells 110 that have undergone thermal runaway may not pass through the flame-retardant members 220. Through this, flames may be prevented from being propagated across the entire region of the battery cells 110 via the venting holes 290.

Although embodiments or aspects have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the disclosure and appended claims. Additionally, it is to be understood that the present disclosure contemplates that, to the extent possible, one or more features of any embodiment or aspect can be combined with one or more features of any other embodiment or aspect.

What is claimed is:

1. A battery assembly comprising:
a plurality of battery cells arranged along a stacking direction;
a receiving case forming a receiving space for receiving the plurality of battery cells;
a plurality of flame-retardant members disposed between one surface of the receiving case and the plurality of battery cells;
a partition portion located between the plurality of flame-retardant members along the stacking direction to separate the plurality of flame-retardant members from each other; and
a plurality of venting holes penetrating the one surface of the receiving case and disposed to overlap the plurality of flame-retardant members.

2. The battery assembly according to claim 1, wherein melting points of the plurality of flame-retardant members are higher than a melting point of the receiving case.

3. The battery assembly according to claim 1, wherein each of the plurality of flame-retardant members comprises at least one of copper (Cu), nickel (Ni), or any combination thereof.

4. The battery assembly according to claim 1, wherein thicknesses of the plurality of flame-retardant members are equal to or less than a thickness of the receiving case.

5. The battery assembly according to claim 1, wherein each of the plurality of flame-retardant members has porosity.

6. The battery assembly according to claim 5, wherein PPI (pores per inch) of the plurality of flame-retardant members is a value of 10 or more and 1500 or less.

7. The battery assembly according to claim 5, wherein thermal conductivities of the plurality of flame-retardant members are values of 1 W/m·K or more and 100 W/m·K or less.

8. The battery assembly according to claim 5, wherein each of the plurality of flame-retardant members comprises a metal foam or a combination of ceramic wool and a metal foam.

9. The battery assembly according to claim 1, wherein at least a portion of the plurality of flame-retardant members is exposed to the outside of the receiving case through the plurality of venting holes.

10. The battery assembly according to claim 1, wherein each of the plurality of battery cells comprises:
a body portion comprising an electrode assembly; and
a lead tab portion electrically connected to the electrode assembly and protruding to an outside of the body portion, and
wherein the plurality of venting holes are disposed to overlap the lead tab portion in a vertical direction of the battery assembly.

11. The battery assembly according to claim 1, wherein each of the plurality of venting holes is disposed to be adjacent to a side surface of the receiving case along the stacking direction.

12. The battery assembly according to claim 11, wherein the receiving case comprises:
a receiving cover forming an upper surface of the receiving space;
a receiving bottom surface facing the receiving cover and supporting the plurality of battery cells; and
a first receiving side surface and a second receiving side surface extending from the receiving bottom surface toward the receiving cover and forming both side surfaces of the receiving space along the stacking direction,
and wherein the plurality of venting holes comprise:
first venting holes formed in the receiving cover and disposed closer to the second receiving side surface than to the first receiving side surface; and
second venting holes formed in the receiving cover and disposed closer to the first receiving side surface than to the second receiving side surface.

13. The battery assembly according to claim 1, further comprising a heat blocking member disposed between the plurality of battery cells along the stacking direction.

14. The battery assembly according to claim 1, wherein the partition portion extends in a direction perpendicular to the stacking direction to separate adjacent ones of the plurality of battery cells from each other.

15. A method of assembling a battery assembly comprising a plurality of battery cells, a receiving case for receiving the plurality of battery cells, and a partition portion located between a plurality of flame-retardant members along a stacking direction to separate the plurality of flame-retardant members from each other, the method comprising:
receiving the plurality of battery cells arranged along the stacking direction in a receiving body that is a part of the receiving case;
coupling the plurality of flame-retardant members and the partition portion on upper portions of the plurality of battery cells; and
coupling a receiving cover on the plurality of flame-retardant members, the receiving cover being coupled to the receiving body to form the receiving case together with the receiving body and comprising a plurality of venting holes disposed to overlap the plurality of flame-retardant members.

16. The method of assembling a battery assembly according to claim 15, further comprising disposing a heat blocking member between adjacent ones of the plurality of battery cells to separate the adjacent battery cells from each other.
